(19) United States
(12) Patent Application Publication
(10) Pub. No.: US 2026/0024985 A1
(43) Pub. Date: Jan. 22, 2026

(54) DEVICE FOR PROTECTING A CIRCUIT CONNECTED TO A POWER SUPPLY SYSTEM FROM OVERVOLTAGES

(71) Applicant: Turck Holding GmbH, Halver (DE)

(72) Inventor: Thomas Riese, Solingen (DE)

(73) Assignee: Turck Holding GmbH, Halver (DE)

(21) Appl. No.: 19/270,765

(22) Filed: Jul. 16, 2025

(30) Foreign Application Priority Data
Jul. 18, 2024 (DE) 10 2024 120 342.0

(51) Int. Cl. H02H 3/20; H02H 1/00

(52) U.S. Cl. CPC H02H 3/20; H02H 1/0007

(57) ABSTRACT

A device for protecting a circuit that is connected to a power supply system from overvoltage, the device comprising an electrical input, an electrical output, and an electrical protective circuit including a detection section, a semiconductor switch and a limiting section, wherein the semiconductor switch is arranged between the electrical input and the electrical output, wherein the detection section is configured to activate the semiconductor switch using an activation voltage such that an output of the output voltage is interrupted when the input voltage reaches a threshold value; wherein the detection section includes a voltage threshold detector element configured to determine when the input voltage reaches the threshold value; wherein the limiting section is configured to limit the activation voltage when the output voltage is interrupted; and wherein the detection section includes a component configured to limit a current flowing through the voltage threshold detector element.

### CROSS REFERENCE TO RELATED APPLICATION

This application claims priority to German patent application 10 2024 120 342.0 filed on Jul. 18, 2024, which is hereby incorporated by reference in its entirety.

### TECHNICAL FIELD

The present disclosure relates to a device for protecting a circuit that is connected to a power supply system, optionally to a power supply system of a vehicle, from overvoltages. For example, the device can be set up to protect a circuit or a device which is connected to a power supply system of a vehicle having an alternator or an electric generator. The disclosure is therefore in the field of circuit engineering, protective circuits and, optionally, the avoidance of damage due to overvoltages in vehicle electrical systems.

### BACKGROUND

In various use scenarios, for example in vehicles having an alternator, high overvoltages can occur due to fluctuations of the load current. This may occur when the connection to the vehicle battery is relatively high-resistant or is disconnected completely. Due to the inductance of the alternator, high induced voltages may arise in the event of rapid changes of the load current, which induced voltages are output as voltage peaks. In this case, the energy stored in the magnetic field of the alternator is output to the vehicle electrical system in whole or in part in the form of a voltage overshoot. The effect is generally known as “load dump”.

A further influence arises due to the finite speed of the charge controller and the inductance of the excitation circuit, as a result of which the excitation current can only change at a finite rate. This likewise leads to a voltage overshoot if the load current is stopped.

The load dump can, due to the overvoltage, cause considerable damage to circuits or devices that are connected to a vehicle electrical system. These devices may for example be sensors or actuators.

Various strategies have been proposed for how electric devices can be protected from such voltage peaks. DE 10 2017 123 484 A1 describes an overvoltage protection circuit and a high-voltage protection circuit for motor vehicles is known from US 2002/0109952 A1, which protects an electric load from damage and/or current interruption in the event of overvoltage conditions, and US 2003/0223169 A1 describes an overvoltage protection circuit and a series-pass circuit for protecting an electric load from damage due to overvoltage. Also, US 2004/0061379 A1 finally describes a system for protecting a vehicle system from a load dump. In US 2014/0002941 A1, an overvoltage protection circuit with self-biased latch is described.

A protective circuit can be provided, in which subsequent circuit parts are protected by means of voltage limitation. There may be difficulties here if the circuit can only be loaded to a limited extent with respect to overvoltage pulses that are repeated in rapid succession.

Furthermore, it is known to integrate voltage limitation by means of transil diodes or Zener diodes in the rectifier of the alternator. This is typically limited to approximately 80 V voltage, so that this protection alone is not sufficient without further measures to ensure comprehensive protection.

In known systems, in the event of an overvoltage, the voltage supply of the device to be protected is typically interrupted and furthermore, it may be provided that a current flows via a resistor and dissipation of the energy of the voltage peaks occurs due to the warming of the resistor. This process leads to considerable loading of the components, so that the circuit is durable only to a limited extent, optionally in the case of frequent and/or long-lasting overvoltage pulses.

For example, the on-board electrical system can be short-circuited (crowbar), wherein high current intensities come about and high local power losses likewise occur. Furthermore, the connection can be disconnected, wherein no outsized power losses occur locally and no current flows, but rather the energy of the overvoltage stays at a different place in the on-board electrical system, for example in the transil diodes of the alternator.

### SUMMARY

A device for protecting a circuit that is connected to a power supply system from overvoltage is provided, the device comprising an electrical input for receiving an electrical input voltage, an electrical output for outputting an electrical output voltage to the power supply system or to the circuit, and an electrical protective circuit including a detection section, a semiconductor switch and a limiting section. The semiconductor switch is arranged between the electrical input and the electrical output, the semiconductor switch being configured to interrupt the output voltage at the electrical output when being activated. The detection section is configured to activate the semiconductor switch using an activation voltage such that an output of the output voltage is interrupted when the input voltage reaches a (predefined, optionally defined by a breakthrough voltage of a Zener diode) threshold value. The detection section includes a voltage threshold detector element configured to determine when the input voltage reaches the threshold value. The limiting section is configured to limit the activation voltage of the semiconductor switch when the output voltage is interrupted. The detection section includes a (current-imprinting) component configured to limit a current flowing through the voltage threshold detector element.

A device for protecting a circuit that is connected to a power supply system from overvoltage is provided, the device comprising an electrical input for receiving an electrical input voltage, an electrical output for outputting an electrical output voltage to the power supply system or to the circuit, and an electrical protective circuit including a detection section, a semiconductor switch and a limiting section. The semiconductor switch is arranged between the electrical input and the electrical output, the semiconductor switch being configured to interrupt the output voltage at the electrical output when being activated. The detection section is configured to activate the semiconductor switch using an activation voltage such that an output of the output voltage is interrupted when the input voltage reaches a (predefined) threshold value. The detection section is configured to determine when the input voltage reaches the threshold value. The limiting section is configured to limit the activation voltage of the semiconductor switch when the output voltage is interrupted. The limiting section includes a (current-imprinting) component configured to limit a current flowing through the voltage threshold detector element.

### BRIEF DESCRIPTION OF THE DRAWINGS

In the drawings:

FIG. 1 shows a schematic diagram of a first exemplary embodiment of the device having a p-channel field effect transistor; and

FIG. 2 shows a schematic diagram of a second exemplary embodiment of the device having an n-channel field effect transistor.

### DETAILED DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail in order to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

One possible object of the present disclosure may be to provide a device of the type mentioned above, which offers a reliable and robust protection of electric components from overvoltage pulses and which can be used in a long-lasting and flexible manner.

Accordingly, the object may be achieved by a device for protecting a circuit that is connected to a power supply system, optionally to a power supply system of a vehicle, from overvoltages. The device comprises an electrical input for applying an input voltage, for example for connection to the alternator of the vehicle. It further comprises an electrical output for outputting an electrical output voltage to the power supply system and possibly to a circuit that is connected to the power supply system or an electrical consumer. It additionally comprises an electrical protective circuit having a detection section, a semiconductor switch and a limiting section. In this case, the semiconductor switch is arranged between the electrical input and the electrical output and can be activated such that the outputting of the output voltage at the electrical output can be interrupted or is interrupted. In this case, the detection section is set up to activate the semiconductor switch by means of an activation voltage such that the output of the output voltage is interrupted or that the output of an electric power via the electrical output is interrupted, if a threshold value of the input voltage is reached or exceeded. In this case, the detection section has a voltage threshold detector element, for example a Zener diode. In this case, the limiting section is further set up to limit the activation voltage for the semiconductor switch, optionally to a specified/particular maximum value, if the output voltage is disconnected. In this case, the detection section comprises a current limiting component that limits a current flowing through the voltage threshold detector element (optionally by impressing the current).

The current limiting component may comprise a current sink or constant current source. As a result, in the event of relatively large overvoltages, the semiconductor switch may be prevented from being damaged or destroyed by a correspondingly high activation voltage that is acting on it.

The device can further be designed to be able to cope with very heavy demand using simple means, which concerns the durability with respect to practically arbitrarily frequent and long overvoltage pulses.

In the following, “circuits” that are to be protected may be understood as circuits, components and/or devices which are connected to the power supply system.

In the device, the detection section may provide the activation voltage, by means of which the semiconductor switch is activated.

“Current sink” may be understood to mean a circuit which is used, in the event of an overvoltage, to limit the current in the components and thus to ensure that no current that is damaging for the device flows. Optionally, the current intensity that occurs is prevented from exceeding a specified value. Optionally, unexpectedly high currents inside the device are avoided as a result.

A current sink can for example be realized by means of a combination of a transistor, a resistor and a reference voltage. For example, a transistor can be used, the collector of which is connected to the output of the voltage that is to be limited, whilst the emitter is connected to the chassis ground. A resistor that is connected to the collector or between base and emitter in series can control the current through the base of the transistor.

A stable voltage reference can for example be provided by a Zener diode in order to control the base-emitter voltage of the transistor.

If the input voltage exceeds a fixed value, the Zener diode begins to conduct. The current sink in this case limits the current through the Zener diode to a permitted value.

The Zener diode in connection with the current sink can monitor the input voltage and limits the current flow if the voltage exceeds a particular value, for example a transistor in a closed-loop control system is used for that.

The detection section can comprise a Zener diode which is set up such that it blocks a current flow until the threshold value of the input voltage is reached.

The detection section can be formed in a simple manner and using readily available components. Optionally, current flows above the threshold value of the input voltage, so that the Zener diode is used as sensor element for the threshold value of the input voltage being reached or exceeded.

The semiconductor switch can be designed as a p-channel field effect transistor, optionally as a p-channel MOSFET.

The gate connection of the semiconductor switch, optionally the semiconductor switch that is designed as a p-channel field effect transistor, can be connected via a transistor to the detection section and can be activated by said transistor.

Suitable p-channel MOSFETs, which are suitable for example for a specified maximum test voltage of 207 V or for other voltages above 200 V, have poor availability on the market however. A circuit variant can enable the use of n-channel MOSFETs. This can result in a greater selection of suitable components.

The semiconductor switch can be designed as an n-channel FET, optionally as an n-channel MOSFET. These components are advantageously available with better dielectric strength.

Compared to a circuit of the device for n-channel transistors, for a p-channel FET the activation takes place using negative gate voltage compared to the source voltage. If this option is not available directly, it is possible to implement an alternative activation of the semiconductor switch.

The detection section can be connected to a galvanic isolation element such that when the threshold value of the input voltage is exceeded, the semiconductor switch is activated by means of the galvanic isolation element such that the output of the output voltage is interrupted. This embodiment can be used for a semiconductor switch having an n-channel FET.

The galvanic isolation element can include an optocoupler, optionally with a solar cell. The galvanic isolation element can for example be designed as an optocoupler having a light-emitting diode and a solar cell.

The device can be designed for protecting the power supply system in the event of a load dump, optionally in the case of an alternator of a vehicle, which is connected to the electrical input. Optionally, provision is made for appropriate dimensioning of the parts here, so that the protection of the circuit from overvoltage pulses of the input voltage can be accomplished.

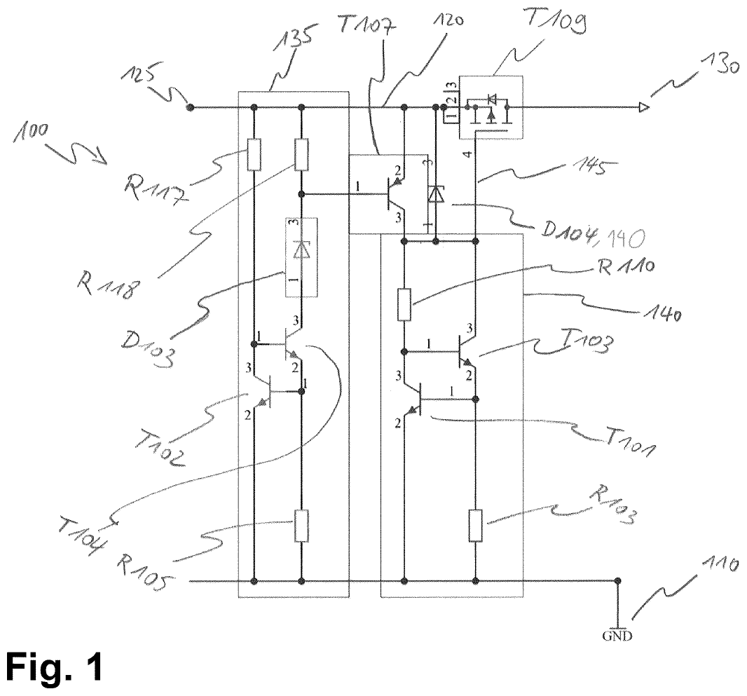

A schematic diagram of a first exemplary embodiment of the device having a p-channel field effect transistor is explained with reference to FIG. 1.

The device 100 of the first exemplary embodiment has an electrical input 125, to which an input voltage can be applied. In the first exemplary embodiment of the device 100, the electrical input 125 is connected to an alternator of a vehicle.

The device 100 further has an electrical output 130, via which an electrical output voltage can be output. In the first exemplary embodiment, an electrical circuit is connected as consumer to the electrical output 130, for example a sensor. One example of a connected sensor can be a radar sensor of a vehicle.

A connecting line 120 leads from the electrical input 125 to the electrical output 130.

The device 100 additionally has a connection 110 to a (chassis) ground potential (GND).

The device 100 comprises an electrical protective circuit having a detection section 135 and a limiting section 140 which are connected to the connecting line 120, and also a semiconductor switch T109 that is arranged in the connecting line 120.

The semiconductor switch T109, which in the first exemplary embodiment is designed as p-channel FET T109, is arranged between the electrical input 125 and the electrical output 130, so that it can open or close the current flow to the circuit that is connected to the electrical output 130.

The semiconductor switch T109 can in this respect be compared with a valve which can open and close the flow of the current from the electrical input 125 to the electrical output 130.

The detection section 135 is designed to activate the semiconductor switch T109 by means of an activation voltage. The detection section 135 is designed in the first exemplary embodiment to detect an overvoltage when 47 V is exceeded and to output the activation voltage to the semiconductor switch T109 such that the circuit that is to be protected is disconnected from the input voltage.

The detection section 135 comprises a first constant current source, a second resistor R118 and a first diode D103 connected in series to the second resistor R118, the first constant current source being configured to limit a current flowing through the first diode D103. The first constant current source comprises two resistors R105, R117, and two transistors T102, T104. More specifically, in a first branch between the electrical input 125 and the connection 110 to the ground potential, the detection section 135 comprises a first resistor R117 and a transistor T102 connected downstream of that. Parallel to that, in a second branch, a second resistor R118 is connected, a second transistor T104 is connected downstream of that, and in turn a third resistor R105 is connected downstream of that. The base of the second transistor T104 of the second branch is connected to the first branch between the first resistor R117 and the first transistor T102. The base of the first transistor T102 is connected to the second branch between the second transistor T104 and the third resistor R105.

The first and second branches of the detection section 135 are connected between the electrical input 125 and the semiconductor switch T109.

In the second branch, the first Zener diode D103 is further arranged, in reverse-biased manner from the electrical input 125 to the connection 110 of the ground potential, between the second resistor R118 and the second transistor T104. The first Zener diode D103 blocks a current flow until the input voltage that is applied at the electrical input 125 reaches or exceeds a threshold value which is 47 V in the first exemplary embodiment.

Two further connections for a first and a second branch of the limiting section 140 are arranged between the connections of the first and second branches of the detection section 135 and the semiconductor switch T109.

The limiting section 140 comprises a second constant current source and a second diode D104, the first constant current source being configured to limit a current flowing through the second diode D104. The second constant current source comprises two resistors R110, R103, and two transistors T101, T103. More specifically, a fourth resistor R110 and a third transistor T101 are arranged in a first branch of the limiting section 140. A fourth transistor T103 and downstream of that a fifth resistor R103 are arranged in reverse order in a second branch of the limiting section 140. The base of the fourth transistor T103 is connected to the first branch between the fourth resistor R110 and the third transistor T101. The base of the fourth transistor T103 is connected to the second branch downstream of the fourth transistor T101.

The limiting section 140 is connected via two further lines to the connecting line 120. A fifth transistor T107 is arranged in one of these lines here, the base of which is connected to the second branch of the detection section 135 between the second resistor R118 and the first Zener diode D103. When the first Zener diode D103 becomes conductive, i.e. when the input voltage that is applied at the electrical input 125 reaches or exceeds the threshold value, a current is supplied to the base of the fifth transistor T107 and the fifth transistor T107 also becomes conductive. When the fifth transistor T107 is in a conductive state, the activation voltage is applied to a gate of the semiconductor switch T109 and the semiconductor switch T109 interrupts the current flowing from the input 125 via the line 120 to the output 130.

The limiting section 140 is further connected to a gate connection of the semiconductor switch T109 by means of an activation line 145. Here, the activation voltage can therefore not only be applied to the gate connection of the semiconductor switch T109 in order to switch the electrical connection between the electrical input 125 and the electrical output 130 by means of this semiconductor switch T109 but limited to a certain threshold to avoid damage of the switch 109.

More specifically, a second Zener diode D104 is arranged in the other of the lines connecting the limiting section 140 to the connecting line 120 in a reverse-biased manner starting from the connecting line 120.

The second Zener diode D104 is designed such that in the first exemplary embodiment it becomes conductive in the reverse direction when a further threshold value of for example 18 V is reached or exceeded. The further threshold value of 18 V is the maximum voltage that should be applied to the gate of the switch 109. Thus, the limiting section 140 limits the voltage applied to the gate of the switch 109 to said further threshold value.

Due to the switching of the detection section 135 in collaboration with the limiting section 140 of the device 100 and the described activation of the semiconductor switch T109, the occurrence of a voltage peak of more than 47 V can be detected and in this case, the semiconductor switch T109 is activated by means of its gate connection such that the circuit to be protected at the electrical output 130 of the device 100 is disconnected from the input voltage at the electrical input 125. At the same time, the limiting section 140 in this case ensures that the activation voltage is limited and that the current is also limited by means of a current sink. In this manner, the semiconductor switch T109 is protected from damage due to the voltage peaks.

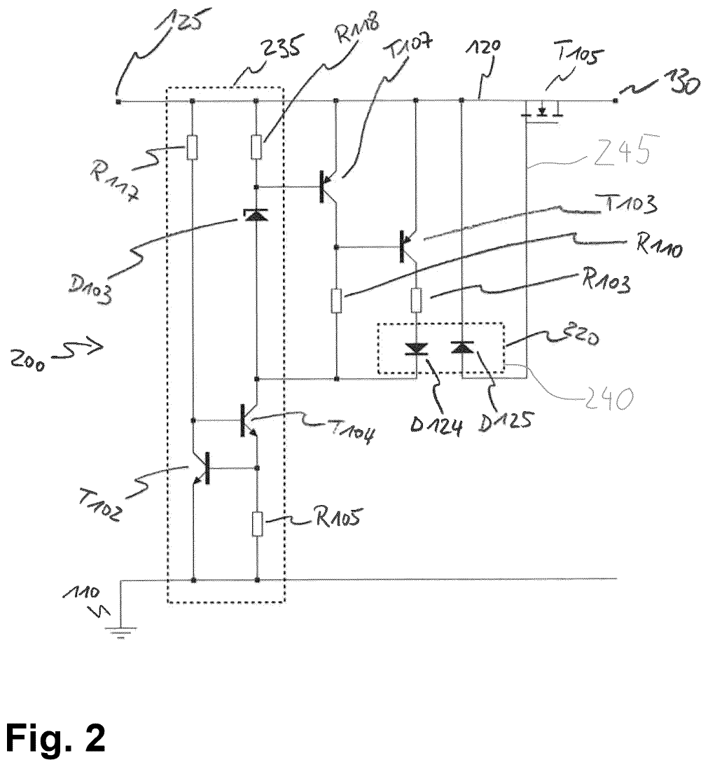

A schematic diagram of a second exemplary embodiment of the device having an n-channel field effect transistor is explained with reference to FIG. 2. Where the structure is analogous to the first exemplary embodiment, the explanations above with reference to FIG. 1 are assumed and the elements are not described anew in detail. Furthermore, the same or similar reference symbols are used where functionally and/or structurally comparable elements are used; this should not imply that these are the same components as are in the first exemplary embodiment.

Also, in the device 200 according to the second exemplary embodiment, an electrical input 125 and an electrical output 130 are provided, between which a semiconductor switch T105 is arranged.

In the second exemplary embodiment, the semiconductor switch T105 is designed as an n-channel FET T105. This switch T105 is also arranged such that it can open or close the current flow to the circuit that is connected to the electrical output 130.

To produce the connection however, a positive activation voltage compared to the source connection is required at the gate connection of the semiconductor switch T105. In order to be able to provide this, different activation is provided in the second exemplary embodiment.

An optocoupler 220 is provided, which functions as a galvanic isolation element and thus the limiting section 240. The optocoupler 220 comprises a light-emitting diode D124 which is arranged in forward-biased manner between the connecting line 120 and the first Zener diode D103 of the detection section 235. The optocoupler 220 further has a solar cell D125 which is arranged in forward-biased manner in the activation line 245 between the connecting line 120 and the gate connection of the semiconductor switch T105.

When the threshold value of 47 V is reached or exceeded by the input voltage at the electrical input 125, the optocoupler 220 provides an activation voltage for the semiconductor switch T105 such that the semiconductor switch T105 disconnects the connection to the circuit that is to be protected at the electrical output 130.

In this exemplary embodiment, the activation voltage is limited in that the current is limited by means of the detection and limiting section 235.

In other words, in the disclosure a device 100 is provided with a protective circuit which includes two parts: A first part (detection section 135) of the protective circuit detects the occurrence of an overvoltage from a certain level and then acts on the second part (limiting section 140) of the circuit. The second part, which additionally in this case also includes a semiconductor switch, acts as a type of “valve” which is inserted in the supply line of the device that is to be protected. This valve disconnects the electrical connection to the circuit that is to be protected due to the action of the first part. As a result of this, the overvoltage does not act on the circuit that is to be protected. The valve must therefore be able to carry the overvoltage that occurs completely without enabling a current flow or without the valve itself being damaged. The valve can be realized as a field effect transistor.

By means of suitable dimensioning, the proposed protective circuit can withstand an overvoltage event of practically unlimited length. In this manner, damage is limited in the case of a malfunction, in that the protected circuit is disconnected from the energy supply line for as long as necessary.

### REFERENCE SYMBOLS

100 Device
110 Connection (earth)
120 Connecting line
125 Electrical input
130 Electrical output
135 Detection section
140 Limiting section
145 Activation line
R103 Resistor
R105 Resistor
R110 Resistor
R117 Resistor
R118 Resistor
T101 Transistor
T102 Transistor
T103 Transistor
T104 Transistor
T107 Transistor
T109 Semiconductor switch, p-channel FET
D103 Voltage threshold detector element, diode, Zener diode
D104 Diode, Zener diode
200 Device
220 Galvanic isolation element, optionally optocoupler
235 Detection section
240 Limiting section
245 Activation line
T105 Semiconductor switch, n-channel FET
D124 Diode, light-emitting diode (optocoupler)
D125 Diode, solar cell (optocoupler)

What is claimed is:

1. A device for protecting a circuit that is connected to a power supply system from overvoltage, the device comprising
an electrical input for receiving an electrical input voltage;
an electrical output for outputting an electrical output voltage to the power supply system or to the circuit; and
an electrical protective circuit including a detection section, a semiconductor switch and a limiting section;
wherein the semiconductor switch is arranged between the electrical input and the electrical output, the semiconductor switch being configured to interrupt the output voltage at the electrical output when being activated;
wherein the detection section is configured to activate the semiconductor switch using an activation voltage such that an output of the output voltage is interrupted when the input voltage reaches a threshold value;
wherein the detection section includes a voltage threshold detector element configured to determine when the input voltage reaches the threshold value;
wherein the limiting section is configured to limit the activation voltage of the semiconductor switch when the output voltage is interrupted; and
wherein the detection section includes a current limiting component configured to limit a current flowing through the voltage threshold detector element.

2. The device according to claim 1, wherein the current limiting component includes two transistors.

3. The device according to claim 1, wherein the voltage threshold detector element is or includes a Zener diode.

4. The device according to claim 3, wherein the Zener diode is configured to block a current flow until the threshold value of the input voltage is reached.

5. The device according to claim 1, wherein the semiconductor switch is or includes a p-channel field effect transistor.

6. The device according to claim 1, wherein a gate connection of the semiconductor switch is connected to the detection section and is configured to be activated by a transistor.

7. The device according to claim 1, wherein the semiconductor switch is or includes an n-channel FET.

8. The device according to claim 7, wherein the limiting section is or includes a galvanic isolation element and the detection section is connected to the galvanic isolation element, wherein the galvanic isolation element is configured to activate the semiconductor switch such that the output of the output voltage is interrupted when the threshold value of the input voltage is reached.

9. The device according to claim 8, wherein the galvanic isolation element is or includes of an optocoupler.

10. The device according to claim 8, wherein the current limiting component of the detection section is configured to limit a current flowing through the galvanic isolation element.

11. The device according to claim 9, wherein the optocoupler includes at least one of a solar cell and an LED.

12. The device according to claim 1, wherein the device is configured to protect the power supply system in an event of a load dump.

13. The device according to claim 12, wherein the device is configured to protect the power supply system in the event of the load dump in a case of an alternator of a vehicle, which is connected to the electrical input.

14. The device according to claim 1, wherein the device is configured to protect the circuit that is connected to the power supply system of a vehicle.

15. A device for protecting a circuit that is connected to a power supply system from overvoltage, the device comprising:
an electrical input for receiving an electrical input voltage;
an electrical output for outputting an electrical output voltage to the power supply system or to the circuit; and
an electrical protective circuit including a detection section, a semiconductor switch and a limiting section;
wherein the semiconductor switch is arranged between the electrical input and the electrical output, the semiconductor switch being configured to interrupt the output voltage at the electrical output when being activated;
wherein the detection section is configured to activate the semiconductor switch using an activation voltage such that an output of the output voltage is interrupted when the input voltage reaches a threshold value;
wherein the detection section includes a voltage threshold detector element configured to determine when the input voltage reaches the threshold value;
wherein the limiting section is configured to limit the activation voltage of the semiconductor switch when the output voltage is interrupted; and
wherein the detection section includes a current limiting component configured to limit a current flowing through the limiting section.
